(19) United States
(12) Patent Application Publication
(10) Pub. No.: US 2014/0147366 A1
(43) Pub. Date: May 29, 2014

(54) PROCESS FOR PRODUCING CARBON FIBRES

(71) Applicant: Matthias Berghahn, Moers (DE)

(72) Inventor: Matthias Berghahn, Moers (DE)

(73) Assignee: EVONIK DEGUSSA GmbH, Essen (DE)

(21) Appl. No.: 14/116,780

(22) PCT Filed: Apr. 19, 2012
(86) PCT No.: PCT/EP2012/057116

§ 371 Date: Feb. 11, 2014

(30) Foreign Application Priority Data
May 10, 2011 (DE) 10 2011 075 595.0

(51) Int. Cl. C01C 3/10; C01B 31/02

(52) U.S. Cl. CPC C01C 3/10; C01B 31/02
USPC 423/379; 423/447.1; 422/187

(57) ABSTRACT

The invention relates to a process for producing carbon fibres, in which polyacrylonitrile (PAN) is pyrolytically carbonized with liberation of hydrocyanic acid (HCN) to form carbon fibres and also a plant for carrying out the process.

It is an object of the invention to make the process more economical.

This is achieved by utilization of the hydrocyanic acid as material by collecting the hydrocyanic acid liberated and scrubbing it by means of an alkaline medium to give a liquor containing cyanide salt.

The invention relates to a process for producing carbon fibres, in which polyacrylonitrile (PAN) is pyrolytically carbonized with liberation of hydrocyanic acid (HCN) to form carbon fibres and also a plant for carrying out the process.

A technically matured process employed in industry for producing carbon fibres is to carbonize polyacrylonitrile (PAN) pyrolytically, i.e. with a high input of heat. In this chemical elimination reaction, carbon fibres remain and hydrocyanic acid (HCN) and hydrocarbons (HC) volatilize into the furnace atmosphere.

Since hydrocyanic acid is toxic and must not get into the environment, the hydrocyanic acid is, according to the prior art, separated off from the furnace atmosphere and burnt. The heat evolved here is used for preheating the feed to the furnace. The nitrogen oxides obtained in this combustion of hydrocyanic acid are catalytically purified with addition of ammonia.

In the light of this prior art, it is an object of the invention to make the process more economical.

This is achieved by the hydrocyanic acid liberated being collected and scrubbed by means of an alkaline medium to give a liquor containing cyanide salt.

The invention thus provides a process for producing carbon fibres, in which polyacrylonitrile (PAN) is pyrolytically carbonized with liberation of hydrocyanic acid (HCN) to form carbon fibres and in which the hydrocyanic acid liberated is collected and scrubbed by means of an alkaline medium to give a liquor containing cyanide salt.

The basic concept of the invention is no longer to utilize the hydrocyanic acid obtained to generate energy (combustion) but as a material. Hydrocyanic acid is a valuable starting material for the preparation of liquors containing cyanide salt, especially for the preparation of liquors containing sodium cyanide (NaCN) or potassium cyanide (KCN).

Sodium cyanide or potassium cyanide is in turn used for the extraction of gold. With the high gold prices at present, sodium cyanide and potassium cyanide also command high prices, which makes it economically attractive to utilize the hydrocyanic acid which is in any case formed in existing plants as material.

The outlay in terms of apparatus is clear to see: existing plants for carbon fibre production at present collect hydrocyanic acid in order to burn it. Instead, the plant is supplemented in a simple way with a hydrocyanic acid neutralization apparatus, a technology which is available commercially. The hydrocyanic acid neutralization apparatus comprises a scrubber which scrubs the hydrocyanic acid by means of an alkaline medium, in particular sodium hydroxide (NaOH) or potassium hydroxide (KOH). Contact of the hydrocyanic acid with the alkali forms sodium cyanide or potassium cyanide and water. A liquor containing sodium cyanide or potassium cyanide, the corresponding feed alkali (NaOH/KOH) and water collects at the bottom of the scrubber. The product of value sodium cyanide or potassium cyanide can be removed from this liquor in a known way.

To compensate for the heat loss of the hydrocyanic acid which is no longer burnt in a furnace, the hydrocyanic acid is to this extent replaced by natural gas.

Overall, the additional capital investment in a hydrocyanic acid neutralization apparatus and purification and the additional purchase of natural gas appears to be economically viable since in return the nitrogen oxide purification can be omitted and the added value achieved by the additional opportunity of marketing sodium cyanide/potassium cyanide is increased.

Preference is given to preparing sodium cyanide from the alkaline medium since sodium hydroxide (NaOH) is cheaper than potassium hydroxide.

The pyrolysis process in the furnace preferably takes place at temperatures in the range from 500 to 1500° C. and more preferably in an inert atmosphere, in particular under nitrogen.

The invention further provides a plant for producing carbon fibres by the process of the invention, which comprises a furnace which is set up to generate temperatures of from 500 to 1500° C. in such a way that polyacrylonitrile (PAN) introduced into the furnace can be carbonized under the action of heat to form carbon fibres and is provided with means of taking up the hydrocyanic acid (HCN) liberated in the carbonization, which has a scrubber by means of which the hydrocyanic acid taken up can be contacted with an alkaline medium, in particular sodium hydroxide (NaOH) or potassium hydroxide (KOH), and which is provided with collection means for collecting a liquor containing cyanide salt formed on contacting of the hydrocyanic acid with the alkaline medium.

1. A process for producing carbon fibres, the process comprising pyrolytically carbonizing a polyacrylonitrile with liberation of hydrocyanic acid to form carbon fibres, wherein the hydrocyanic acid liberated is collected and scrubbed with an alkaline medium to obtain a liquor comprising a cyanide salt.

2. The process according to claim 1, wherein the hydrocyanic acid liberated is scrubbed with sodium hydroxide to obtain a liquor comprising sodium cyanide.

3. The process according to claim 1, wherein the hydrocyanic acid liberated is scrubbed with potassium hydroxide to obtain a liquor comprising potassium cyanide.

4. The process according to claim 1, wherein the pyrolytic carbonizing occurs at a temperature ranging from 500 to 1500° C.

5. The process according to claim 1, wherein the pyrolytic carbonizing occurs in an inert atmosphere.

6. A plant for producing carbon fibres, the plant comprising:
a furnace configured to generate temperatures of from 500 to 1500° C. and such that a polyacrylonitrile introduced into the furnace is carbonized under the action of heat to form carbon fibres;
a scrubber in which hydrocyanic acid removed from the furnace is contacted with an alkaline medium;
a collector for collecting a liquor containing a cyanide salt formed by the contacting of the hydrocyanic acid with the alkaline medium.

7. The process according to claim 2, wherein the pyrolytic carbonizing occurs at a temperature ranging from 500 to 1500° C.

8. The process according to claim 3, wherein the pyrolytic carbonizing occurs at a temperature ranging from 500 to 1500° C.

9. The process according to claim 1, wherein pyrolytic carbonizing occurs under a nitrogen atmosphere.

10. The process according to claim 2, wherein the pyrolytic carbonizing occurs in an inert atmosphere.

11. The process according to claim 2, wherein the pyrolytic carbonizing occurs under a nitrogen atmosphere.
